(19) United States
(12) Patent Application Publication
(10) Pub. No.: US 2011/0016001 A1
(43) Pub. Date: Jan. 20, 2011

(54) METHOD AND APPARATUS FOR RECOMMENDING BEAUTY-RELATED PRODUCTS

(75) Inventor: David Schieffelin, New York, NY (US)

Correspondence Address: VENABLE LLP, P.O. BOX 34385, WASHINGTON, DC, 20043-9998, US

(73) Assignee: 24/8 LLC, New York, NY (US)

(21) Appl. No.: 12/514,223

(22) PCT Filed: Nov. 8, 2007
(86) PCT No.: PCT/US07/23512

§ 371 Date: Oct. 8, 2010

(30) Foreign Application Priority Data
Nov. 8, 2007 (US) PCT/US07/23512

(51) Int. Cl. G06Q 30/00; G06N 3/08

(52) U.S. Cl. 705/14.66; 706/25

(57) ABSTRACT

Disclosed is a method for recommending products to a potential customer, comprising obtaining an image of a customer, creating an image vector template of a customer, matching the image vector template of the customer with stored templates by local feature analysis template matching, performing skin color/texture analysis template matching process, and recommending products to the customer.

### FIELD

Disclosed is a method and system for recommending beauty-related products to a customer.

### BACKGROUND

Applications exist that inquire of user specific beauty-related questions to collect personal beauty care information related to the individual user. Personal information including a user's demographics, geographical location, lifestyle, and other related personal data is collected. The collected information is used to generate a beauty-related diagnosis and to provide the user with a list of potential products that may be used to satisfy the beauty-related diagnosis. For instance, in response to questions, the user may indicate that they have an oily complexion and enjoy spending time in the sun. In response to this combination of answers, the system may prescribe certain facial products to overcome the oily skin condition and to also protect the skin from the sun.

Systems have been described that utilize a neural network to identify inconsistencies that may be input by the user in the personal information that is collected. The neural network is used to either challenge the user's response to the personal information question or to override the user's input based on the combination of other factors that have already been input by the user. Prior art systems do not generally otherwise change the personal information unless specifically requested by the user. For instance, the personal information collected about a lifestyle such as “frequently attends the gym” is not adjusted unless specifically requested to do so by the user. Therefore, if the user discontinues using the gym, the system will not alter its selection of products for the respective user. The purpose of this is to minimize the frequency of interaction between the system and the user to avoid the need for the user to continuously enter data already input into the system. As a result the system does not actively inquire of the user's current status.

### SUMMARY

Disclosed is a method for recommending products to be sold or otherwise provided to or acquired by a customer, comprising obtaining an image of a customer, creating an image vector template of a customer, matching the image vector template of the customer with stored templates by local feature analysis template matching, performing skin color/texture analysis template matching process, and recommending products to the customer.

Also, disclosed is a system for implementing obtaining an image of a customer, creating an image vector template of a customer, matching the image vector template of the customer with stored templates by local feature analysis template matching, performing skin color/texture analysis template matching process, and recommending products to the customer.

Further disclosed is a computer readable medium for causing a computer to execute obtaining an image of a customer, creating an image vector template of a customer, matching the image vector template of the customer with stored templates by local feature analysis template matching, performing skin color/texture analysis template matching process, and recommending products to the customer.

### BRIEF DESCRIPTION OF THE DRAWING FIGURE

The present invention shall be described by reference to exemplary embodiments, to which it is not limited, as shown in the accompanying drawing figure, wherein:

FIG. 1 is a schematic diagram of a stand alone computer, stand alone kiosk and a computers and kiosks connected to a network with databases and servers.

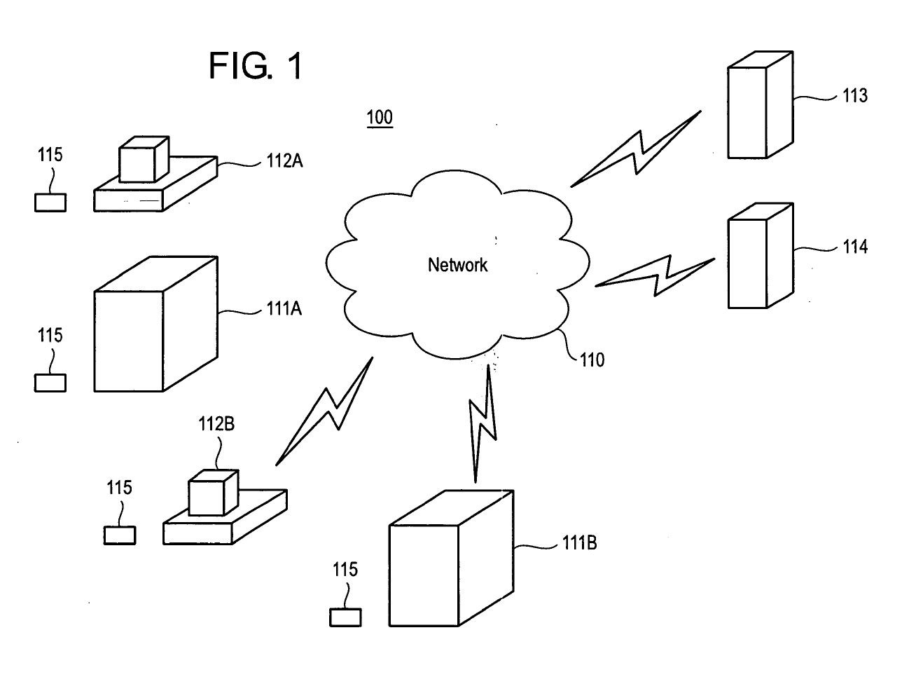

### DETAILED DESCRIPTION

In an exemplary embodiment, a neural network embodied in a stand alone computer 112A, a stand alone kiosk 111A, or on a network 100 either in the end-user terminals (computer 112b or kiosk 111B) or on centralized or distributed servers 113, 114 that include databases and computers that are connected over a network 10 (e.g. a closed network, virtual network or open network such as but not limited to the Internet, connected by any means including wirelessly) analyzes user data (e.g., a user's demographics, geographical location, lifestyle, and other related personal data) to adaptively provide the user with additional product choices based on an initial inquiry of the user's present status. The user data can be accessed over the network 110, or can be provided by the user through memory devices 115 (such as smart cards or any form of non-volatile memory including but not limited to magnetic memory, optical memory, solid state memory, indicia on a medium, etc.) In the present disclosure, the kiosks 111A, 111B, desk-top, lap-top or hand-held computers 112A, 112B are sometimes referred to as Intelligent Merchandising Interfaces or IMIs.

As examples of the system making an initial inquiry of the user, the system may inquire of the user's mood, plans, environment, time of day, etc. to determine which type of product should be provided to the user and the products necessary for the user to achieve an overall appearance based on the user's response to the system's inquiries. For example, the system upon receiving an answer that the user is “happy and excited” might recommend a colorful eye shadow that would brighten the user's eyes and further recommend the shade of lipstick or lip gloss to compliment the recommended eye shadow. Alternatively, the system can make suggestions based on social functions that the person may be attending, e.g., dinner party, beach party, or formal luncheon, time of day the user wants to look his or her best, environment (e.g., office with bright lighting, restaurant with romantic lights, etc.), or planned activity (e.g., dancing, pool activities, sports, dining, etc.).

An exemplary embodiment of a system utilizes a user interface that allows a user to input personal information related to cosmetic products that the user prefers, and facilitates input of an image of the user for receiving personal appearance information, such as eye color, hair color and preferences in applying cosmetics or make-up. The user interface can be as simple as a monitor and keyboard, mouse and graphic user interfaces (GUIs), memory medium 115 readers, networks computers and databases for accessing databases internally or off-site, or mixtures thereof The user interface can be located in a plurality of locations, such as a kiosk 111A, 111B in a mall or a department store for example, or computer terminals 112A, 112B at these locations or in a residence, for example.

Using the user interface, which can be wireless, whether or not connected to a client computer or to a network of a cosmetic retailing company, different products and services based on the data input by the user can be provided to or recommended to the user.

As part of a business plan, the system may be initially available at only retail establishments where the products are being sold so the user can use some self help to determine which product(s) to purchase. In addition, sales personnel can be present to assist the user, there being excitement in a computerized system for assisting in identifying products, rather than depending on the sometimes variable and inconsistent opinions and knowledge dependent on which sales person is being consulted. Additionally, sales persons may make further recommendations on which products the user should use and also which products the user may desire to use.

As information is obtained, a neural network or learning network will track user's selections and interests to learn these preferences for future suggestions of additional products or new products that the user may be interested in purchasing. As the user or customer base becomes more familiar with the system, it can be installed in other locations such as kiosks 111A, 111B and computers 112A, 112B at home of in the office, various types of hand-held computing devices such as Personal Digital Assistants (PDAs), wireless phones and wireless e-mail devices, and potentially linked together via the network 110 or the memory devices 115.

These other locations may be kiosks 111A, 111B located outside of the retail establishment, but still in a commercial setting. The kiosks 111A, 111B will allow a user to selectively purchase products either through the recommendation of the system or based on previous use of a particular product, either at that location or through on-line ordering for instance. Finally, when the user has become accustomed to the kiosk format of obtaining beauty product advice, the system can be then provided for home and/or office use.

In the home or office, the user interface can be available over the user's personal computer via the Internet, for example, at a particular website. In this setting, the user can order products for delivery or for in store pickup based on the user's previous use or based on recommendations from the system based on the collective inputs from the retail store locations as well as the kiosk based on the output of a neural network.

The Intelligent Merchandising Interface (IMI) (e.g. the kiosks 111A, 111B, desk-top, lap-top or hand-held computers 112A, 112B) as mentioned above can be implemented in three phases which can, but do not have to, overlap in a particular market segment, for instance.

In addition to the locations and distribution of the IMIs, the IMIs might operate at different levels of functionality, which can be introduced sequentially or by market segment, generically referred to as phases herein. In the first of the three phases, user interaction is relatively high compared to the other phases. For instance, a step can be to establish a dialogue using a recorded voice or even just text prompts or both, in which the user will be requested to answer some general questions regarding the user's appearance and the customer's/user's connection with the store (e.g., does the customer have a credit or other account at the particular store or chain of stores) in which the IMI is located. This additional information can be used to gather additional information about the customer and his or her buying habits and past purchases. This information can have an impact on the selection of recommendations or level of service provided to the customer.

For example, the system may inquire as to the face shape, the face/skin shade, hair color, body shape, specific facial features, (e.g., eyebrow shape). The system may also inquire about various demographic information, user interests, geographic information, life-style choices or changes, etc., to further customize product recommendations. The IMI may then record the body shape history and be capable of making changes to the stored information. This information can then be used to tie into the store or chain points of sale inventory system, thereby allowing the system to assist the customer through personalized recommendations based on available inventory or for later delivery, and access the customer through various affinity programs. To the degree available, data on the customer's earlier purchases can also facilitate selecting specific recommendations.

In addition, an image of the user/consumer can be obtained so that changes of the user/consumer data based on a specific event such as alterations in hair color, hair style, or weight loss, for instance, can be factored into future consulting sessions and recommendations. The image can be a digital image storable on a computer readable medium 115 for portability by the user or to be stored at the particular location inaccessible via a network 110 such as the Internet. As mentioned above, the user's plans can factor into the recommendation selection process, and might include specific inquiries of the user or consultation with the user's electronic day planner, particularly if customized to include indications about the user's planned environment and basic activities (in-office appointments verses outdoor sports activities, as contrasting examples).

The IMI can be a specific device arranged in a specific store location or viewing a free-standing kiosk, for example, within a retail store. For example, the IMI can be used to offer private, periodic and even daily dressing advice for a more up-scale effect on the consumer. Beyond color selection of make-up and clothes, it can assist in the selection of the types and even specific clothes based on the user's prior history, the user's current appearance, the user's planed activity and external data. For instance, a user might receive one recommendation or set of recommendations for his or her normal activity (e.g., office work) of which there might be strong history and other data for the system to draw upon in making the recommendations, but also the ability to access external data for activities the user might not have much history or experience (e.g., dressing for a fox hunt), and the system can be configured to assist at various levels, in any of the various phases discussed herein depending on the needs and interests of the user and the provider of the IMI. In other words, the user experience can be adjusted to the user and/or retailers needs or desires.

In the second of the three phases, the system can be capable of analyzing handwriting or by utilizing birthdates to provide additional analyzes and interpretations. For instance, the birth date can be tracked to age, demographic information, or even to a zodiac sign and common astrological tendencies of persons if the user is so interested, to suggest or recommend products for use. Additionally the system can have sensors capable of detecting skin water content and skin texture to offer product/lifestyle adjustments to the user. By being tied to the store or chain point of sale/inventory system, the system will be able to recommend multiple brands of products related to the information collected as well as suggesting clothing suggestions for complimenting various body types. For instance, brand A's blouses may run smaller than brand B's blouses of the same size, and therefore it would be more appropriate if the user was going to use a brand B blouse based on body type having a larger frame. Other examples might include specific blends, types, brands, and the like of makeup, clothing or accessories.

Although exemplary embodiments of the system conduct a dialogue using a particular recorded voice, any type of voice can be utilized and may mimic for instance accents to accommodate various dialects and accents, so as to more closely relate to the customer/user, or impersonate famous people for instance.

An IMI can be used as expert counter-help in department stores for instance, makeup advice from a famous makeup artist, or Ralph Lauren for example tells the user in the dressing room what product the user should buy, or Tom Ford telling a user why the user he or she will smell great.

The IMI can use a method for interactive facial type recognition, analysis, and matching for cosmetic requirements profiling. The method uses novel or existing algorithms based on Artificial Intelligence (AI) and neural networks. Image databases can be built that contain facial images for cosmetic rendition analysis. Various techniques of pattern recognition, computer imaging/graphics, image processing, statistical analysis and machine learning can be implemented on computer hardware and software.

A facial pattern recognition algorithm can be used to analyze the captured image. The facial pattern recognition algorithm can, for example, create a vector representation stacks of all pixels from a two-dimensional captured facial image into various specified orders. The facial image is a visual pattern that is a two-dimensional appearance of a three-dimensional object captured by an imaging system. This facial visual appearance will be affected by the configuration of the imaging system. Multi-level neural networks can be used to reduce the effects of imaging system configuration.

Local feature analysis can be used to analyze the geometry of the face or the relative distances between predefined features such as the spacing between the eyes, nose shape, mouth configuration, and similar features. Eye position and the size of the face in the image are determined and analyzed. Skin biometrics are performed to analyze the uniqueness in color/texture and randomly formed features to form a unique skin color/texture identifier. A facial screening algorithm that uses real time face search, face recognition and tracking can be implemented to allow for the presence and position of a person in an image field of view, and captured by a CCD camera. Facial image templates are created that are mathematical representations of the captured image field. This mathematical template enables the methods algorithms to operate on this data because this data is encoded in a series of bits and bytes. This comparison of facial image against a facial template allows for greater speed and reduced storage size as compared to other techniques such as direct two facial image comparisons. An exemplary facial comparison algorithm uses a combination of geometrical queues and pattern matching to find heads and facial features.

An embodiment of the method can be capable of detecting the presence of multiple faces in an image and determine the position of each of the faces. The recognition algorithm is capable of accurately recognizing the presence of a face even in images with non-frontal poses. The recognition algorithm can preferably find faces anywhere in the image at arbitrary scale. Adjustable parameters, such as image pixel units, are used to determine spacing of facial features in an image, for instance, by determining a number of pixel units between the centers of the eyes. Search and recognition algorithms can, in combination or individually, find facial images and return a score indicating the best face matches found.

The facial image capture process can incorporate an analysis of whether an image is suitable for facial recognition. Image quality can be automatically evaluated following image capture but prior to serialization to the image database or prior to a matching attempt, in order to verify that the facial image will be useful in automated face recognition. In situations where the initial image is below a predetermined standard, live enrollments into the system with feedback that can be used to acquire a better image of the user. An image quality library can be built into the system for image quality assessment. Various ways of normalizing the image for color skew and lighting variations (defined background, color cards, dynamic color recognition, uniform, calibrated imaging devices, prior images of the user, etc.) can all be used individually or in tandem as desired, for example.

An image vector creation algorithm creates the image vector template; this template is then compared to all or a set of vector templates in the database. This exemplary process will score the comparisons and the highest scoring results that include the vector templates are then forwarded to a local feature analysis template matching process module. A local feature analysis template matching algorithm can compare the local feature analysis templates in the image database with each of the local feature analysis template passed forward from the image vector creation process described initially. Finally, skin color/texture analysis template matching algorithm compares the skin color/texture analysis templates in the database with the skin color/texture analysis templates associated with each of the local feature analysis templates passed forward from the local feature analysis template matching process.

The requirements for one-to-many facial screening which includes face segmentation and multiple face search in real-time are fully supported. Algorithms and implementing computer hardware, software or firmware for facial quality assessment, evaluating and classifying facial images are provided in an exemplary embodiment. The facial quality assessment algorithm/module analyzes quality parameters such as non-frontal pose, angle of rotation of the facial image, brightness, darkness, blur, head size, head cropping, use of glasses, compression and resolution. A database stores all original facial images, model images, image vector templates, local feature analysis templates, and skin color/texture analysis templates in an indexed format for high-speed retrieval.

An embodiment of an interactive user interface allows the user to also perform image capture quality assessment and parameter adjustments such as head/face size, cropping (visibility of facial image), centering, exposure (facial image over-exposed/under-exposed), glasses, image focus, compression issues effecting skin details, skin texture issues (detectable), and image resolution (image pixel units for facial dimensions). The user interface in combination with an internal image quality assessment processing module can create image quality scores to determine whether or not to perform further processing on the image or to capture a better facial image.

Training can be performed on human faces to determine the correct significance of each local feature, for example, mouth, nose, or eye positions, by using artificial intelligence techniques and neural networks. This will facilitate the capability to perform facial recognition at varying posing angles. The method utilizes artificial intelligences such as neural nets and Bayesian nets that are trained preferably for human face mapping and matching using an interactive user interface. This interactive user interface can involve the user in making decisions concurrently with MyBeautyTube/GlobalYBF.com consultations, which are not a prescription based on a diagnosis regarding any medical or physiological condition, but providing advice based on lifestyle and self image. The concurrent decision-making enables MyBeautyTube/GlobalYBF.com to be a representation of a cosmetics domain expert's knowledge through a user interface/kiosk design. The user interface can provide recommendations to the customer via a viewing device, e.g. a monitor, printer, handheld display and the like.

Embodiments can be implemented using software, firmware and hardware that are self contained and stored locally on a disconnected small scale, but works using a distributed cluster server-based architecture when implemented on a large scale in a fully networked environment. Web 2.0 implementations can include analytic and database server software back-ends, RSS-type content-syndication, messaging-protocols such as Simple Object Access Protocol (SOAP), standards-based browsers with Javascript and XML (AJAX) and/or Flex support. MyBeautyTube supports blog capability providing support for personal home pages, personal diaries and group daily opinion columns. The weblog is basically a personal home page in diary format. The RSS feed support will allow the user to link to GlobalYBF.com pages and subscribe to it and the user will get notification every time those page changes creating a “live web” experience. This support not only dynamic pages, but dynamic links.

Implementations of the Web 2.0 web services supporting the SOAP web services stack and XML data over HTTP, which is referred to as Representational State Transfer (REST), is provided in other embodiments. Supporting these lightweight programming models allows for loosely coupled systems. Use of RSS and REST-based web services allows for MyBeautyTube's unique ability to syndicate data outwards to the user. Other embodiments can be implemented to seamlessly provide information flow from a handheld device to a massive web back-end, with a personal computer acting as a local cache and control station.

An AJAX interface which allows re-mapping data into new services is supported in other embodiments. The AJAX interface can be used to provide standards-based presentations using XHTML and CSS, dynamic display/interactions using the Document Object Model (DOM), data inter-changes/manipulations using XML/XSLT, asynchronous data retrieval using the XMLHttpRequest protocol and Java/JavaScript for development.

The system as described can be implemented in a kiosk or home computer, which can include an imaging device (e.g., digital (e.g., CCD) camera whether in a telephone camera, web camera, or other imaging device), a microphone, speakers, input/output devices, a computer processor, viewing device, and other output devices, e.g., printer. The computer mediums on which embodiments of the method can be embodied include flash memory devices, disc media and any other physical storage media. In addition, carrier wave embodiments are also considered. The images collected by the digital camera (e.g., telephone camera, web camera, etc.), or other imaging device can be transmitted electronically, and are, preferably, of at least some minimum picture quality.

An interface such as “Virtual Beauty” or “BeautyBot” provides a consultation, rather than a prescription, based on a diagnosis. “Beauty” and a purpose of the presently disclosed system is about giving advice based on lifestyle and self image, not necessarily a prescription based on a diagnosis regarding a medical or physiological condition (although this is made possible by the inventive concepts). Specific products (of course based on quality, affordability, prior selections, etc.) will be sold, but prescription implies (though often does not in fact mean) an empirical judgment made separate from marketing plans. In this way, the neural net is more of a representation of Beauty's knowledge, and the user interface/kiosk design, and otherwise the “look-and-feel” of the user to provide an outcome based on his or her style.

It would be appreciated by those skilled in the art that the present invention can be embodied in other specific forms without departing from the spirit or essential characteristics thereof. The presently disclosed exemplary embodiments are there for considered and all respect to be illustrative and not limiting. The scope of the invention is indicated by the appended claims rather than the foregoing description and all modifications and alterations that come within the meaning and range of equivalents thereof are intended to be embraced therein.

What is claimed is:

1. A method for recommending products to an individual, comprising:
obtaining an image of a individual;
creating an image vector template of a individual;
matching the image vector template of the individual with stored templates by local feature analysis template matching;
performing skin color/texture analysis template matching process; and
recommending products to the individual via an output device.

2. The method of claim 1, further comprising obtaining personal information about the individual.

3. The method of claim 2, wherein the personal information includes information about prior purchases.

4. The method of claim 2, wherein the personal information includes at least one of demographic information, geographic information, the individual's self-assessed mood, the individual's plans, expected environment, time of day, for the relevant future time frame.

5. A system implementing the method of claims 1-4.

6. The system of claim 5, further comprising a neural network for learning information for further customizing the recommendations for an individual.

7. A computer readable medium for causing a computer to execute the method of claims 1-4.
